(19) United States
(12) Patent Application Publication
(10) Pub. No.: US 2006/0098424 A1
(43) Pub. Date: May 11, 2006

(54) Rechargeable flashlight

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/051,719

(22) Filed: Feb. 4, 2005

(30) Foreign Application Priority Data
Nov. 6, 2004 (HK) 04108740.2

(51) Int. Cl. F21L 4/02

(52) U.S. Cl. 362/184; 362/183; 362/200

(57) ABSTRACT

The present invention relates to a flashlight and more particularly relates to a flashlight with three sources of lighting equipped with a circuit adopts regular power supply, power generated by automobile and batteries along with a handle bar. Said handle can move relatively and interactively between position one and position two. At position one, said handle bar aligns with said flashlight itself at parallel direction providing users with an appropriate handle for operation. At position two, said handle bar aligns with said flashlight itself at vertical direction and exposing a charging plug at a bottom part of said body of said flashlight providing users with charging ability and has ability for continuous usage of over eight hours when properly recharged; provides important source for public security, fire-fighting, emergency treatment, disciplinary forces and civil convenience.

### BACKGROUND OF THE PRESENT INVENTION

The present invention relates to a flashlight and more particularly relates to a flashlight with three sources of lighting equipped with a circuit adopts direct current power supply, power generated by automobile and batteries along with a handle bar that aligns with a body of the flashlight in a parallel level to provide user with an appropriate handle. Said handle can move relatively and interactively between position one and position two. At position one, said handle bar aligns with said flashlight itself at parallel direction providing users with an appropriate handle for operation. At position two, said handle bar aligns with said flashlight itself at vertical direction and exposing a charging plug at a bottom part of said body of said flashlight providing users with charging ability.

1. Field of Invention

Military, law enforcement, fire and rescue personnel, security personnel, hunters and recreational boaters among others for nighttime surveillance in any application commonly use handheld flashlights, where a reliable flashlight is required. Nowadays, such application is highly demeaned in all anti-terrorists actions that take place at nighttime. Conditions of use are highly varied, but generally require the light to deliver a desired field of view at long distances, be reliable, durable and field maintainable in order for it to be practically used in the designed applications. Typically a flashlight is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of flashlights are focusing mainly of power sources or power supply to power up flashlights. Seldom of prior arts are aiming to improve the duration of lighting source as most flashlights are used for a rather short period of time. However, it is very obviously that a flashlight with an extended duration of lighting source is so needed.

Also, seldom of prior arts providing any solution to improve the strength of lighting source for flashlights since most conventional flashlights are used for normal usages such as when lighting fixtures at home are all out during storm seasons, during camping or performing repair tasks at where lightings are required. However, at extreme situations such as searching fugitives at dark environments or when fire-fighters are try to save lives at fire, a flashlight with extra strength of lighting source would be much more appropriated.

Many patents provide flashlights which combine both a flashlight with a candle together to ensure said lantern can still light up when power source is done or batteries are all used up. However, the lighting range, lighting angles and the lighting power of a candle are minimal. Such flashlight light up by a candle will not be the most useful tool in an event of a big area.

Also, most conventional flashlights do not provide any mean of self-recharging. Most of them are solely depending on rechargeable batteries. It is not environmental friendly especially in nowadays' tendency when all man kinds are promoting the sense of protecting the environment.

2. Description of Related Arts

### SUMMARY OF THE PRESENT INVENTION

The main object for the present invention is to provide a flashlight having adoptability to more than one lighting source.

Another main object for the present invention is to provide a flashlight having adoptability to more than one power supply source.

Another main object for the present invention is to provide a flashlight having ability to provide mean of built-in rechargeable battery in addition to the regular source of power supply.

Accordingly, in order to accomplish to above objects, a flashlight comprises:

a three-dimensional-type-cylinder structure body, wherein there is an inner chamber for an electric circuit to lies thereon and there is a spotlight unit chamber at one end thereof; and

said spotlight unit with at least three sources of lighting, which is placed inside the spotlight unit chamber, connected to said power circuit device and composed of a photo-electronic cold-cathode illuminating source to provide power supply and lights; and

a parabola-shaped reflector and a transparent front panel are placed at front portion of said inner chamber of said body, and

a switch is placed at a top front portion integrated providing mean of controlling power supply; and

at lease one rechargeable battery is installed underneath of said spotlight unit therein.

### BRIEF DESCRIPTION OF THE DRAWINGS

FIG. 1 is a side view of the present invention;

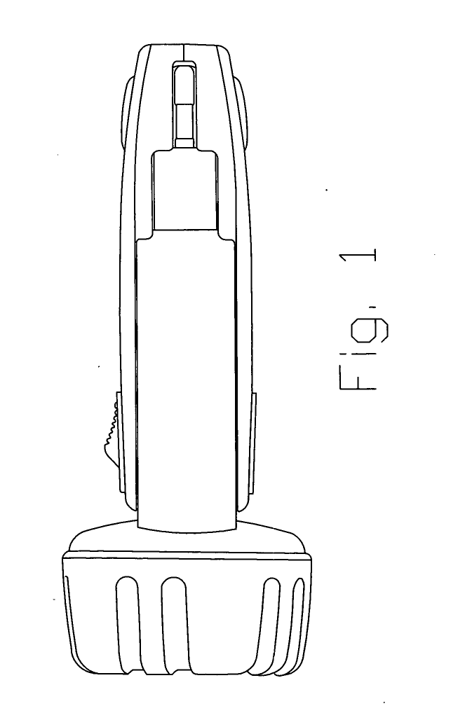

FIG. 2 is a sectional view thereof;

FIG. 3 is a plan view thereof;

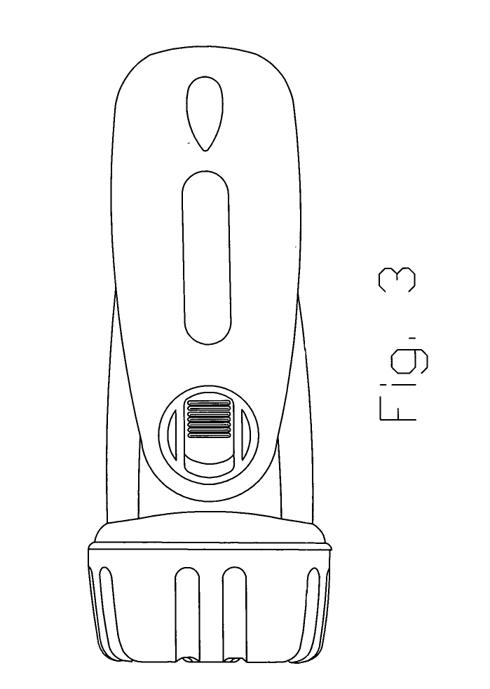

FIG. 4 is an underneath view thereof;

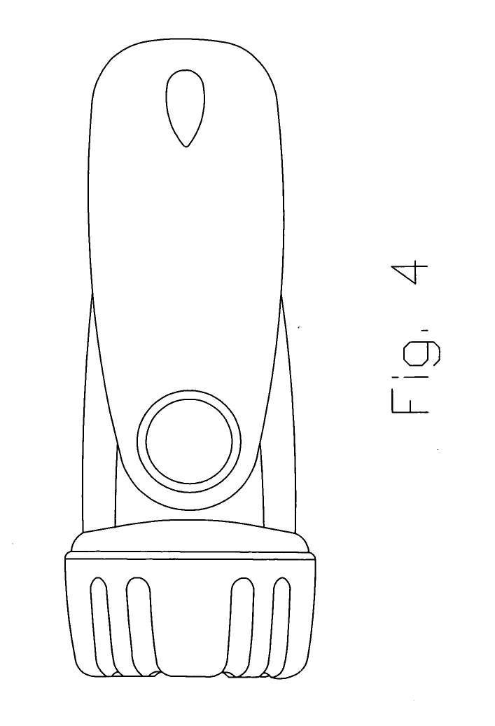

FIG. 5 is front view thereof;

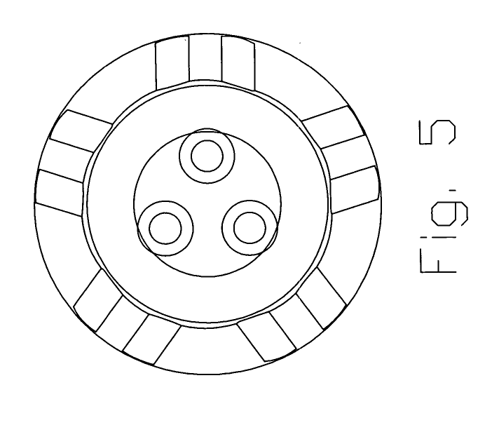

FIG. 6 is a rear view thereof;

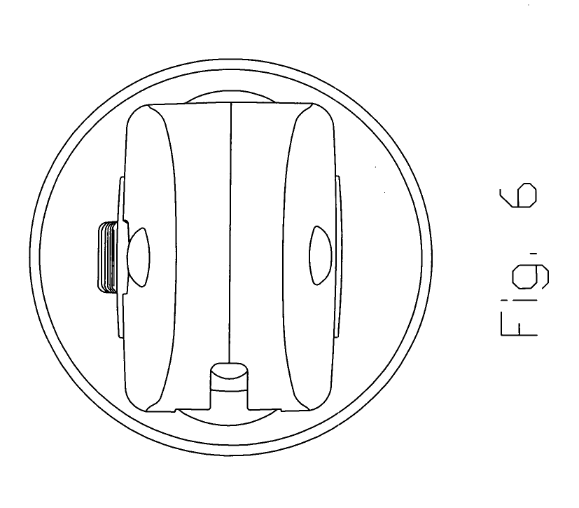

FIG. 7 is another side view thereof;

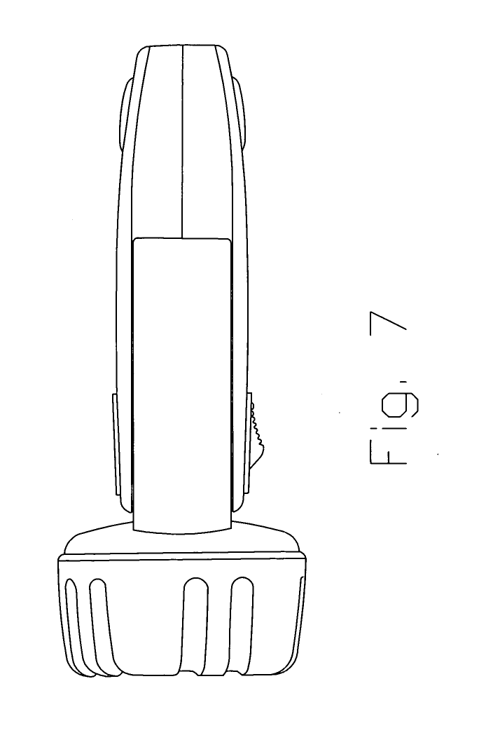

FIG. 8 is a front isometric view thereof;

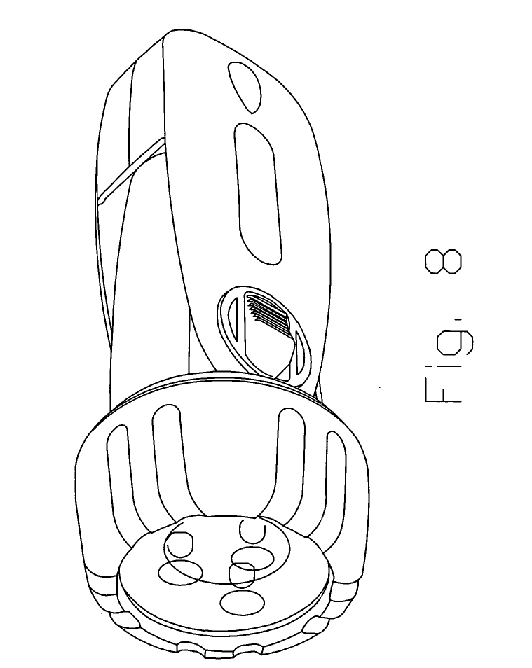

FIG. 9 is a rear isometric view thereof;

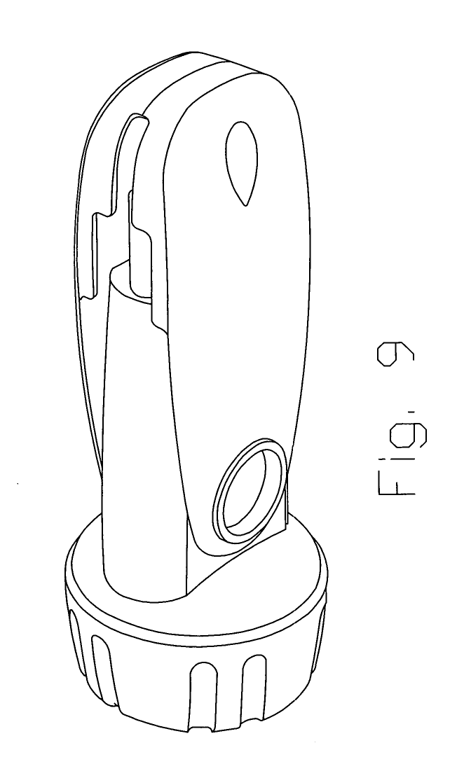

FIG. 10 is a rear isometric view showing the plug beneath the handle thereof;

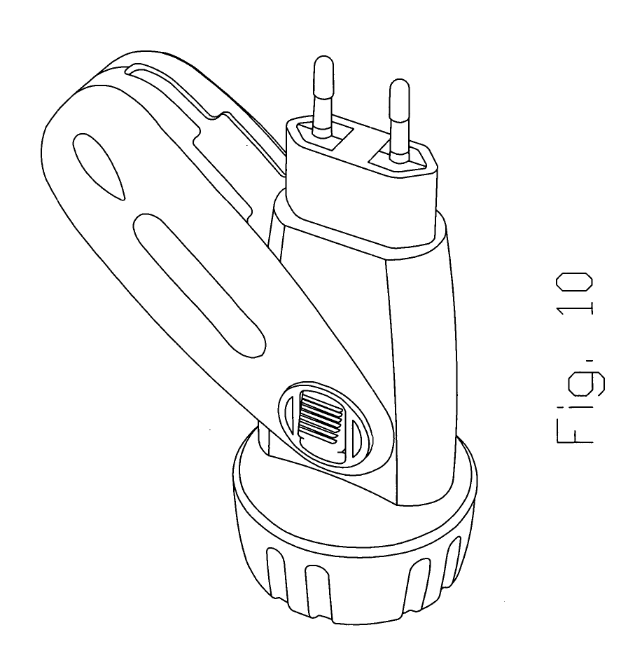

FIG. 11 is a front isometric view showing the plug beneath the handle thereof.

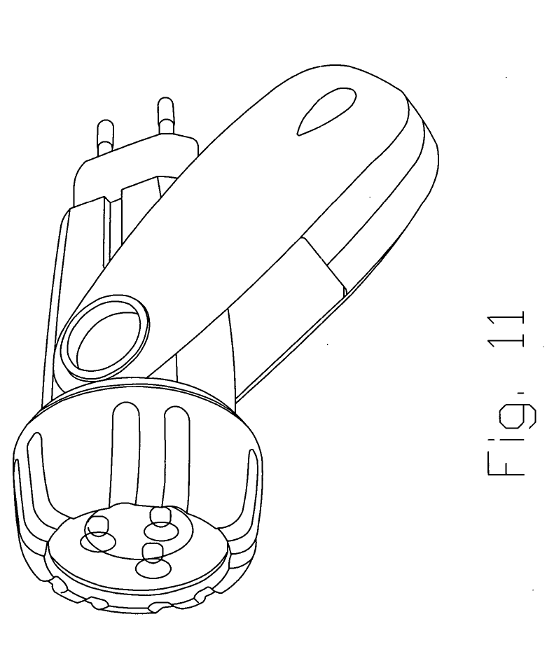

### DETAILED DESCRIPTION OF THE PREFERRED EMBODIMENT

The present invention comprises a three-dimensional-type-cylinder structure body (1) and embracing three sources of lighting (2), a parabola-shaped reflector (3) and a transparent front panel (4). There are three convex lenses (5) on said front panel (4) which seal the end surface of a elastic annular nut (6). Said annular nut (6) is affixed to front end portion of said body (1) in a detachable manner.

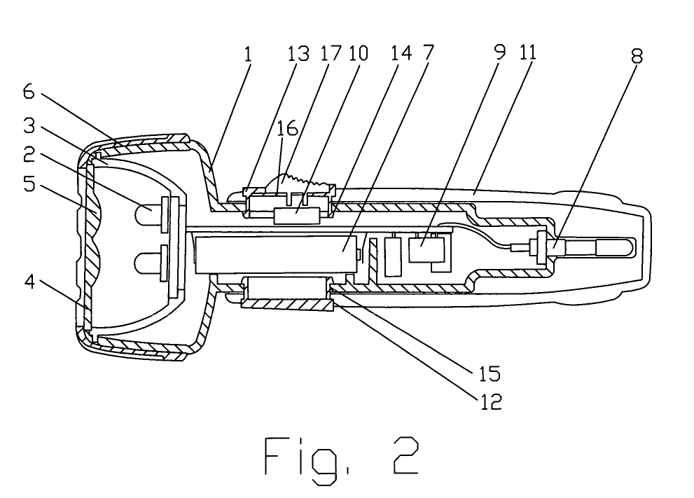

Referring to FIG. 2, said three sources of lighting (2) comprises at least three bulbs, i.e., photo-electronic cold-cathode illuminating and energy-saving source supplied by a rechargeable battery (7) in said body (1). Regular power supply enters an inner body through an external power plug (8) via wall plug-in, and connects to an electric circuit (9) in said body (1); through a power cord to charge said rechargeable battery (7) in said body (1). An electric connective switch (10) of said chargeable battery (7) connects integrally to said photo-electronic cold-cathode illuminating source.

A rear end of said body (1) is affixed to an external regular power plug (8). There are revolving circular hole (15) in both top and bottom ends of said body (1). Said external regular power plug (8) is concealed within a chamber of a handle bar (11) when not in use. Said handle bar (11) is a rectangular cylinder structure and there is a chamber underneath therein. There are revolving circular holes (12) in front, top and bottom ends of said handle bar (11). On top part of said revolving circular hole (12), there is a rotary lock (13), at bottom of which installs a flanged buckle (14). Said rotary clock (13) runs through said revolving circular hole (12) in said handle bar (11) and said revolving circular hole (15) in said body (1). Said flanged buckle (14) of said rotary lock (13) tightens up with an inner surface of said body (1) in a flexible manner. It is obvious that said handle bar (11) and said body (1) are connected together with said rotary lock (13) in a flexible manner. Said handle bar (11) makes relative movements between position one and position two. At position one, said handle bar (11) aligns with said body (1) at a parallel direction to provide users with an appropriate handle for operation. At position two, said handle bar (11) aligns with said body (1) at vertical direction. Said external regular power plug (8) exposes at bottom of said body (1) to provide users with charging ability.

There is a rectangular hole (16) on top of one of said rotary locks (13) in said body (1). There is a switch (10) at bottom of said rectangular hole (16), and a switch cover (17) on top of said rectangular hole (16). The end of said switch cover (17) runs through top of said rotary lock (13) via a rectangular hole (16) to connect closely to said switch (10). In another word, user can push said switch cover (17) and push said switch (10) to turn on said flashlight.

In another word, this present invention of rechargeable flashlight provides a r convenient recharging method for users. At position two, said handle bar (11) aligns with said body (1) at a vertical direction, and said external regular power plug (8) exposes at bottom portion of said body (1), said external regular power plug (8) is plugged into a socket of regular power to recharge said rechargeable battery (7) inside said body (1) with regular power supply. This flashlight has ability for continuous usage of over eight hours after proper charging, and provides usage of public security, fire fighting, emergency treatment, disciplinary forces and regular function as an indispensable source.

What is claimed is:

1. A rechargeable flashlight comprises:
a three-dimensional-type-cylinder structure body, and an electric circuit; and
wherein there is an inner chamber for an electric circuit to lies thereon and there is a plurality of spotlight unit with chamber at one end thereof; and
said spotlight unit with at least three sources of lighting, which is placed inside the spotlight unit chamber, connected to said power circuit device and composed of a photo-electronic cold-cathode illuminating source to provide power supply and lights; and
a plurality of parabola-shaped reflector and
a plurality of transparent front panel are placed at front portion of said inner chamber of said body, and
a plurality of switch is placed at a top front portion integrated providing mean of controlling power supply; and
a plurality of an external power plug, and
at lease one rechargeable battery is installed underneath of said spotlight unit therein, and
a plurality of rectangular cylinder structured handle bar wherein a chamber is provided underneath therein.

2. A rechargeable flashlight a recited in claim 1, wherein said handle bar is s a rectangular cylinder and connected to said body in a flexible manner. Said handle bar makes relative movements between position one and position two. At position one, said handle bar aligns with said body at a parallel direction to provide users with an appropriate handle for operation. At position two, said handle bar aligns with said body at vertical direction. An external regular power plug exposes at bottom of said body to provide users with charging ability.

3. A rechargeable flashlight as recited in claim 1, wherein said electric circuit further comprises:
three sources of lighting comprises at least three bulbs, i.e., photo-electronic cold-cathode illuminating and energy-saving source supplied by a rechargeable battery in said body. Regular power supply enters an inner body through an external power plug via wall plug-in, and connects to an electric circuit in said body; through a power cord to charge said rechargeable battery in said body. An electric connective switch of said chargeable battery connects integrally to said photo-electronic cold-cathode illuminating source.

4. A rechargeable flashlight as recited in claim 1, wherein said electric circuit consists of an external regular power plug at rear end of said body. There are revolving circular hole in both top and bottom ends of said body. Said external regular power plug is concealed within a chamber of a handle bar when not in use.

5. A rechargeable flashlight as recite in claim 1, wherein said handle bar is further comprises:
a plurality of revolving circular holes in front, top and bottom ends of said handle bar; and
on top part of said revolving circular hole, there is a rotary lock, at bottom of which installs a flanged buckle; and
said rotary clock runs through said revolving circular hole in said handle bar and said revolving circular hole in said body. Said flanged buckle of said rotary lock tightens up with an inner surface of said body in a flexible manner. Said handle bar and said body are connected together with said rotary lock in a flexible manner.

6. A rechargeable flashlight as recited in claim 1, wherein, said switch is placed at bottom portion of a rectangular hole which sits on top portions of a rotary locks in said body. There is a switch cover runs through top of said rotary lock via a rectangular hole to connect closely to said switch to provide means of turning on and off said flashlight.

7. A rechargeable flashlight as recited in claim 1, wherein said electric circuit further comprises:
plurality of spotlight unit with chamber at one end thereof; and
said spotlight unit with at least three sources of lighting, which is placed inside the spotlight unit chamber, connected to said power circuit device and composed of a photo-electronic cold-cathode illuminating source to provide power supply and lights; and
a plurality of parabola-shaped reflector and
a plurality of transparent front panel are placed at front portion of said inner chamber of said body, and
a plurality of switch is placed at a top front portion integrated providing mean of controlling power supply; and
a plurality of an external power plug, and
at lease one rechargeable battery is installed underneath of said spotlight unit therein, and

8. An electric circuit for rechargeable flashlight as recited in claim 7, wherein said electric circuit further comprises:
three sources of lighting comprises at least three bulbs, i.e., photo-electronic cold-cathode illuminating and energy-saving source supplied by a rechargeable battery in said body. Regular power supply enters an inner body through an external power plug via wall plug-in, and connects to an electric circuit in said body; through a power cord to charge said rechargeable battery in said body. An electric connective switch of said chargeable battery connects integrally to said photo-electronic cold-cathode illuminating source.

9. An electric circuit for rechargeable flashlight as recited in claim 7, wherein said electric circuit consists of an external regular power plug at rear end of said body. There are revolving circular hole in both top and bottom ends of said body. Said external regular power plug is concealed within a chamber of a handle bar when not in use.

10. An electric circuit for rechargeable flashlight as recited in claim 7, wherein, said electric circuit has a plurality of switch which is placed at bottom portion of a rectangular hole which sits on top portions of a rotary locks in said body. There is a switch cover runs through top of said rotary lock via a rectangular hole to connect closely to said switch to provide means of turning on and off said flashlight.
